(19) United States
(12) Patent Application Publication
(10) Pub. No.: US 2016/0242424 A1
(43) Pub. Date: Aug. 25, 2016

(54) Method for manufacturing ring-shaped multilayered bread

(71) Applicant: GLOBAL SHINWOO CO., LTD., Gyeonggi-do (KR)

(72) Inventors: Sin-Hak KIM, Paju (KR); Yun-Seo JUNG, Paju (KR)

(21) Appl. No.: 15/025,598

(22) PCT Filed: Sep. 22, 2014
(86) PCT No.: PCT/KR2014/008762

§ 371 Date: Mar. 29, 2016

(30) Foreign Application Priority Data
Oct. 11, 2013 (KR) 10-2013-0121510

(51) Int. Cl. A21D 13/00

(52) U.S. Cl. CPC A21D 13/0058

(57) ABSTRACT

The present invention relates to a method for manufacturing ring-shaped multilayered bread and, more specifically, to a method for manufacturing ring-shaped multilayered bread, comprising the steps of: manufacturing a multilayered dough sheet, wherein flour dough layers and milk fat layers are alternatively and thinly laid upon one another; manufacturing a dough ring by rolling up the dough sheet; and inserting the dough ring into a molding frame and baking.

### TECHNICAL FIELD

The present invention relates to a method for manufacturing ring-shaped multilayered bread and, more particularly, to a method for manufacturing ring-shaped multilayered bread, comprising the steps of preparing a multilayered dough sheet by alternately and thinly laminating flour dough layers and milk fat layers so as to be laid upon one another, rolling the dough sheet into a round shape so as to prepare a dough ring, and inserting the dough ring into a molding frame so as to bake the same.

### BACKGROUND ART

In general, multilayered bread indicates pastry-like bread formed of thin layers laid upon one another, forming the inside of the bread.

According to prior art method for producing multilayered bread, a series of work of adding a milk fat layer on a thinly rolled flour dough, folding the flour dough in half, thinly rolling out the flour dough, adding an oil and fat ingredient thereon again, folding the flour dough in half, and then thinly rolling out the flour dough has to be repeated a dozen times. Through this procedure, a multilayered dough having thin flour dough layers and milk fat layers, which are repeatedly laid upon one another, can be obtained, wherein if the multilayered dough is formed in a predetermined shape and inserted into an oven so as to be baked at 180˜230° C. for about 8˜15 minutes, then multilayered bread such as a pastry is finished.

Herein, the molding conditions of the multilayered dough, in particular, the shape or size of the multilayered dough may be very important factors which determine the characteristics of the multilayered bread. For example, if the multilayered dough is cut into small pieces of predetermined size and baked, pies can be produced with crispy texture from both inside and outside portions. In this case, empty space layers resulted from the melting of the milk fat layers are opened to the outside such that strong heat permeates the inside of the bread and thus the both inside and outside portions become crispy.

Meanwhile, if the multilayered dough is rolled in a round shape and then baked, then strong heat does not relatively reach the inside of the bread and steam stuck in the bread is not likely to leak to the outside such that the bread is baked to be crispy just on the surface while the inside of the bread is formed of relatively tender layers. The bread, which is baked after rolling a multilayered dough in a round shape and bending the both ends thereof in the shape of a crescent, is the so-called croissant.

However, since the diameter of the croissant becomes different from the both side end portions to the center portion thereof, the baking degree of the croissant becomes slightly different according to the portions. That is, the croissant as above has a disadvantage that the center portion having a large diameter rises in some degree and thus provides slightly tender texture, while the both side end portions having a relatively small diameter cannot provide tender texture and are likely to be burned in some cases due to the heat reaching the inside. In addition, the croissant in the above shape is much limited in the size of the bread, which can be produced.

Meanwhile, Korean Patent Laid-open Publication No. 10-2013-0103141, published on 23 Sep. 2013, discloses a pastry fried bread, which is produced in a predetermined shape by baking a pastry dough injected into a cast-iron mold, which is used for baking fish-shaped buns or small walnut-flavored cake in the size and shape of a walnut. However, the pastry fried bread also has a disadvantage that since the fried bread is locked and baked in a groove formed in the cast-iron mold, the bread cannot sufficiently rise and thus the size of the bread, which can be produced, is also much limited.

### Technical Problem

Accordingly, the present invention has been made in an effort to solve the above-mentioned problems occurring in the prior arts, and it is an objective of the present invention to provide a method for manufacturing multi-layered bread, in which the inside of bread is formed of layers thinly laid upon one another and the bread can uniformly provide very soft texture from every portion regardless of the size of the bread.

In addition, it is an objective of the present invention to provide a method for manufacturing multi-layered bread, by which bread can be simply produced and delivered and the texture of bread is rarely changed in spite of long time storage.

### Technical Solution

To achieve the above objectives, the present invention provides a method for manufacturing ring-shaped multilayered bread, comprising the steps of: (A) alternately and thinly laminating flour dough layers and milk fat layers so as to be laid upon one another and thus prepare a multilayered dough sheet; (B) rolling the dough sheet into a long shape so as to prepare a dough roll and joining the both side end portions of the dough roll to each other so as to prepare a dough ring in the shape of a ring; and (C) inserting the dough ring into a molding frame and baking the dough ring in a baking oven.

The molding frame used in the step (C) has a central protrusion part, which is formed in the shape of a cylinder so as to be inserted into the center portion of the dough ring, and a round furrow part, which is formed in the periphery of the central protrusion part on the bottom surface of the molding frame so as to receive the dough ring.

### Advantageous Effects

The ring-shaped multilayered bread produced according to the present invention has a uniform thickness of the bread, wherein the steam in the bread is not likely to be discharged to the outside in the process of baking and thus the inside of the bread can uniformly provide very tender texture regardless of the size of the bread.

In addition, as for the ring-shaped multilayered bread produced according to the present invention, the dough rings prepared in the step (B) can be stored and delivered in a frozen state, and final consumers can eat the bread by simply purchasing the dough rings, inserting the dough rings in the molding frame of a predetermined shape and baking the same.

Therefore, everybody including even beginners can easily make tasty multilayered bread.

As described above, the ring-shaped multilayered bread can be commercialized in a finished product state and also can be stored and delivered in a semi-finished product state such as the dough ring. Therefore, the ring-shaped multilayered bread can be very useful for the purpose of sales, particularly, with respect to restaurants and stores such as existing bakeries or cafes, or franchise business.

### DESCRIPTION OF DRAWINGS

FIG. 1 is a photograph for showing a multilayered dough sheet (10) according to the present invention,

FIG. 2 is a photograph of a view, in which the dough sheet (10) is rolled up so as to prepare a dough roll (20),

FIG. 3 is a photograph for showing the shapes of the both side end portions of the dough roll (20),

FIG. 4 is a photograph for showing a dough ring (30) according to the present invention,

FIG. 5 is a photograph for showing a state, in which the dough ring (30) is inserted into a molding frame (40),

FIG. 6 is a photograph for showing the molding frame (40) used in the present invention,

FIG. 7 is a photograph for showing multilayered bread produced according to one embodiment of the present invention, and

FIG. 8 is a photograph for showing a cross-sectional view of the multilayered bread of FIG. 4.

### EXPLANATION OF ESSENTIAL REFERENCE NUMERALS IN DRAWINGS

10: dough sheet 20: dough roll

21, 22: end portion 30: dough ring

40: molding frame 41: central protrusion part

42: furrow part

### Mode for Invention

Hereinafter, the present invention will be described in detail with reference to the accompanying photographs in place of drawings. It should be noted that detailed explanation will be omitted for a technique, which belongs to prior art or could be readily carried out by a person skilled in the art from prior art, even though the technique is essentially required in the implementation of the present invention.

A method for manufacturing ring-shaped multilayered bread, according to the present invention, includes the steps of (A) alternately and thinly laminating flour dough layers and milk fat layers so as to be laid upon one another and thus prepare a multilayered dough sheet, (B) rolling the dough sheet into a round shape so as to prepare a dough roll, and (C) inserting the dough ring into a molding frame so as to bake the same.

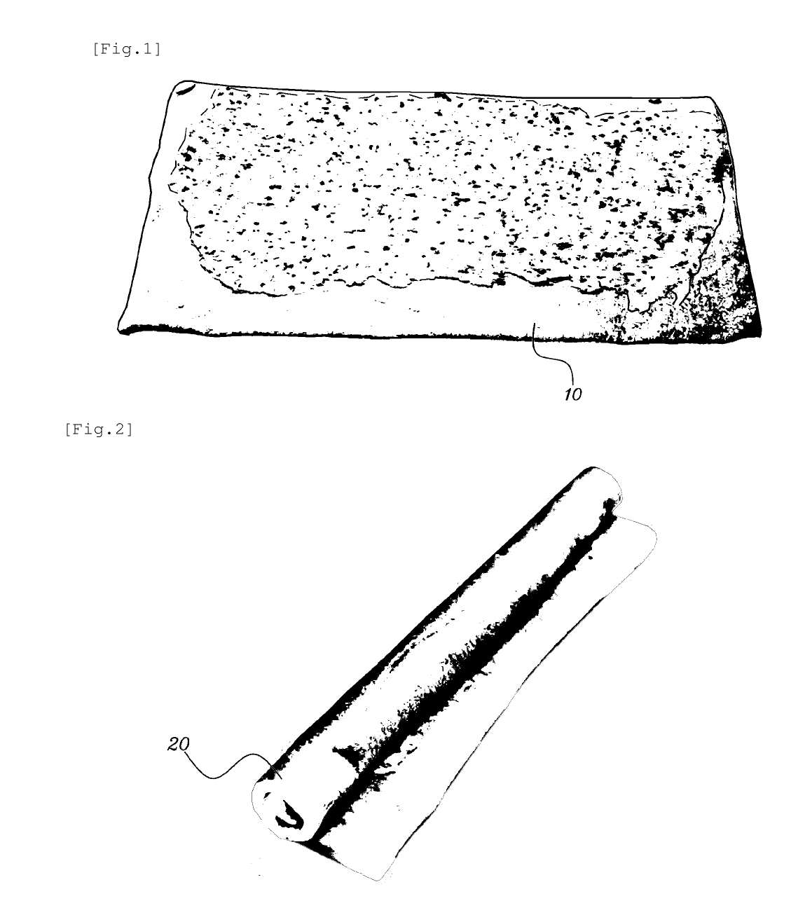

First, in the step (A), the flour dough is prepared with predetermined ingredients according to a composition ratio and is thinly rolled out, and a milk fat layer, for example, a butter layer is added onto one surface of the thinly rolled flour dough. Then, the flour dough is folded in half in such a manner that the butter layer faces to each other and the folded flour dough is thinly rolled out again. After that, a milk fat layer is added again onto one surface of the flour dough and the flour dough is folded in half again and rolled out to be thinly spread. The above procedure is repeated 30˜40 times. Then, a multilayered dough sheet 10 formed of the flour dough layers and the milk fat layers, which are repeatedly and thinly laminated upon one another, can be obtained as shown in FIG. 1.

Herein, even though there is no particular limitation in the flour used for the flour dough, in order to obtain soft inside of the bread while maintaining the bread in shape, it is preferable that strong wheat flour and soft wheat flour are mixed at a ratio of 10:7.

In addition, various food additives or spices can be added to the milk fat layers as necessary, wherein, for example, multilayered bread having garlic taste can be produced if an appropriate amount of shred garlic is added.

The work procedure of the step (A) is preferably carried out at a temperature of 0˜5° C. If the work procedure of the step (A) is carried out at a temperature below 0° C., there are problems that the flour dough may be frozen or hardened such that it is difficult to be thinly rolled out the flour dough and form thin and uniform intervals between the dough layers and the milk fat layers. To the contrary, if the work procedure of the step (A) is carried out at a temperature above 5° C., there are also problems that the milk fat layers are melted and soak into the dough layers during the work procedure such that the dough layers cannot be separated from each other but stick together.

Further, the thickness of the multilayered dough sheet is preferably 4˜7 mm. If the thickness of the dough sheet is less than 4 mm, it is apprehended that the dough sheet may be torn in the process of shaping. To the contrary, if the thickness of the dough sheet is larger than 7 mm, it is apprehended that sufficient rotation number of 3˜4 times cannot be obtained in the process of forming a dough roll 20 in the next step such that the inside of the bread cannot provide uniform texture.

Next, in the step (B), as shown in FIG. 2, the dough sheet is rolled elongatedly like ‘gimbap’ (Korean dish made from steamed white rice and various other ingredients, rolled in dried layer) 3˜4 times so as to prepare the dough roll 20, and the both sides end portions of the dough roll 20 are joined together so as to form a dough ring 30 in the shape of a ring, as shown in FIG. 4.

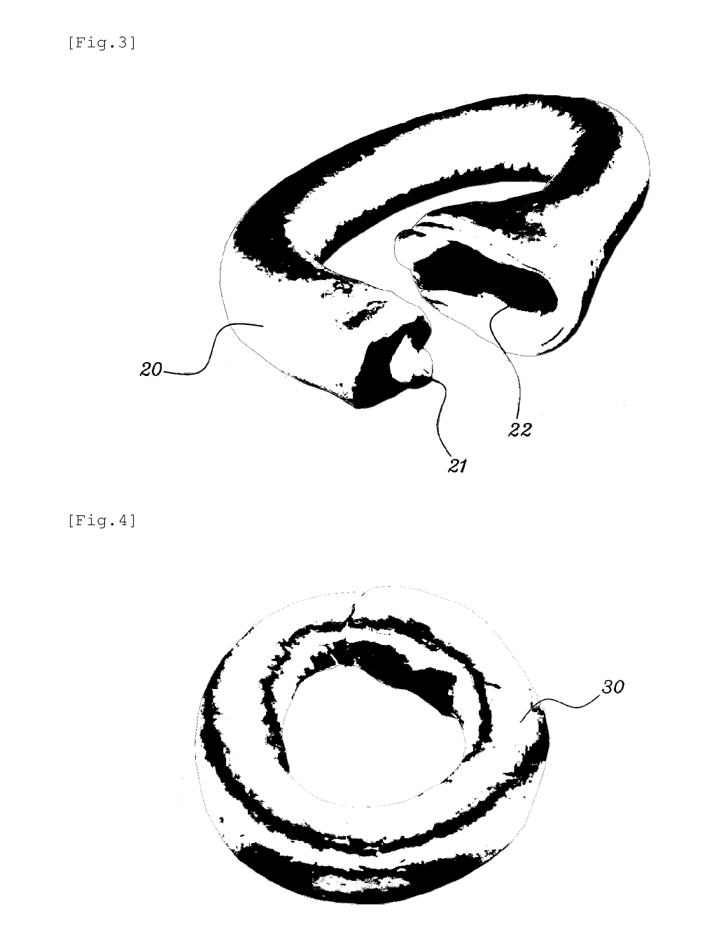

Herein, in order to join the both side end portions of the dough roll 20, it is preferable to carry out male-and-female coupling such that one side end portion 21 can be completely inserted into the other side end portion 22, as shown in FIG. 3, so as to prepare the dough ring 30.

If the both side end portions 21, 22 of the dough roll 20 are joined together through the male-and-female coupling as described above, the flour dough layers and the milk fat layers of the both side end portions 21, 22 are connected to each other such that, when baking the dough ring 30 in the step (C), steam is not discharged to the outside from the inside of the bread and but expands space layers, which are formed by the milk fat layers, so as to sufficiently raise the inside of the bread.

Meanwhile, when preparing the dough roll 20 by rolling the dough sheet 10 in the step (B), it is also possible to insert raisins, chocolate, onions, strawberries, blueberries, and the like to the inside as necessary.

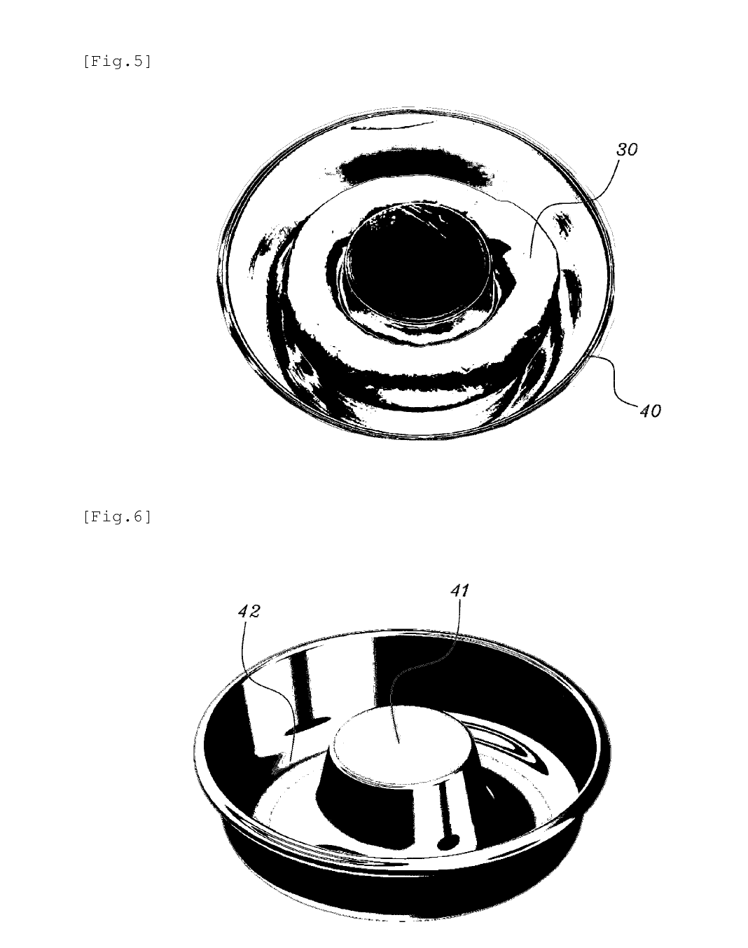

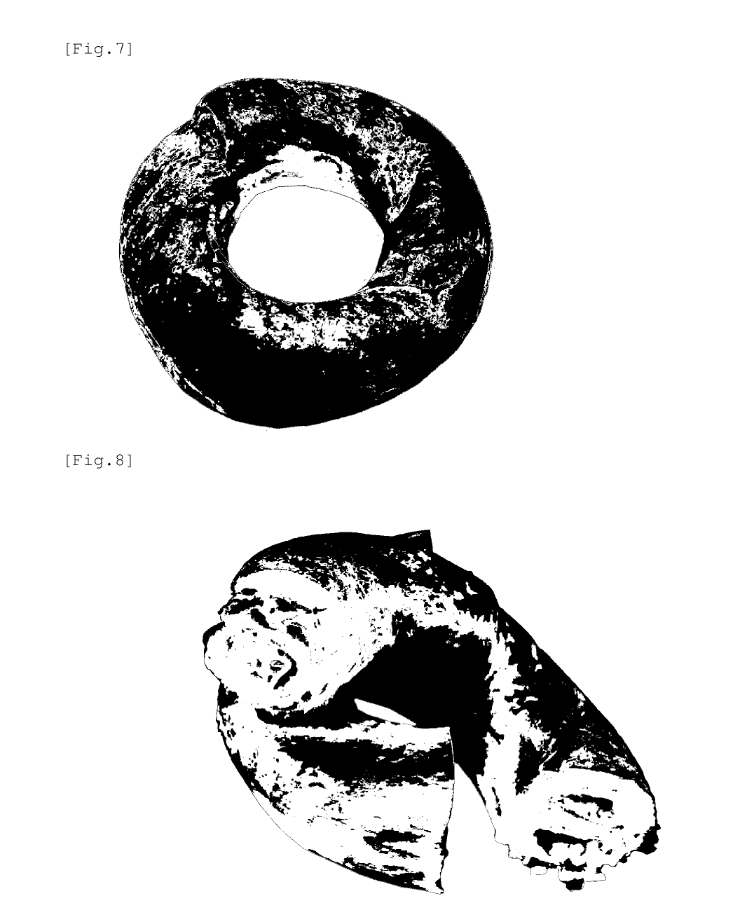

Lastly in the step (C), as shown in FIG. 5, the dough ring is inserted into a molding frame 40, which is specially manufactured according to the present invention, and placed in a baking oven so as to be baked at 180˜230° C. for 15˜20 minutes after aging and fermentation of about 1 hour. Then, the ring-shaped multilayered bread according to the present invention is completely produced.

Herein, as shown in FIG. 6, the molding frame 40 has a structure, in which a central protrusion part 41 is formed in the shape of a cylinder so as to be inserted into the center portion of the dough ring 30 and a round furrow part 42 is formed in the periphery of the central protrusion part on the bottom surface of the molding frame so as to receive the dough ring 30.

The central protrusion part 41 in the molding frame 40 serves to support the dough ring 30, and the furrow part 42 serves to hold the shape of the bread such that the multilayered bread is maintained in a predetermined ring shape while the dough ring 30 rises. Even though there is no particular limitation in the size of the molding frame 40, the outer diameter of the molding frame 40 is preferably 18˜20 cm in consideration of the size of the ring-shaped multilayered bread as a finished product.

In the step (C), the oil and fat ingredient included in the milk fat layers of the dough ring 30 is melted out at such a high temperature such that some of the oil and fat ingredient soaks into the flour dough layers and the remaining is leaked out to the furrow part 42 of the molding frame 40.

Therefore, the space layers are formed in the portions, which are originally occupied by the milk fat layers, the bread rises by the interior steam pressure of the bread, and the flour dough layers form very thin and soft texture. In addition, there is also an effect thus achieved that the surface of the bread does not stick to the molding frame 40 by the oil and fat ingredient leaked out to the furrow part 42.

Hereinafter, the present invention will be described with reference to a preferred embodiment thereof. However, it should be understand that the scope of the present invention will not be limited to the below-mentioned embodiment.

### Embodiment

First, 2,000 g of strong wheat flour, 1,400 g of soft wheat flour, 250 g of sugar, 30 g of salt, 160 g of leavening, 1,000 g of milk, 200 g of butter and 30 eggs were mixed together so as to prepare a flour dough, wherein garlic butter was separately prepared by mixing 1,400 g of butter, 300 g of shred garlic, 150 g of condensed milk, 200 g of fresh cream, 650 g of sugar and 10 g of dried parsley.

The flour dough in amount of 200 g was thinly rolled out in an indoor place at a temperature of 3˜4° C., applied with the garlic butter on one surface thereof and folded in half. The result flour dough was thinly rolled out again, applied with the garlic butter on one surface thereof, folded in half and then rolled out again. This procedure was repeated about 30 times and thus a multilayered dough sheet having a thickness of about 5 mm was obtained.

A dough roll was prepared by elongatedly rolling the dough sheet about 3˜4 times and the both side end portions of the dough roll were joined together by a male-and-female coupling method such that a dough ring in the shape of a ring, in which the outer diameter thereof is about 12 cm, was obtained.

A ring-shaped multilayered bread was obtained by inserting the dough ring into the molding frame, leaving the dough ring for aging for about 1 hour, as shown in FIG. 6, and then baking the same in oven at 200° C. for about 15 minutes. As for the size of the multilayered bread, the outer diameter was measured to be 17˜18 cm.

As a result of cutting the multilayered bread thus produced according to the above embodiment and checking the state of the inside of the bread, it was possible to recognize a structure, in which thin and soft layers were repeatedly laid upon one another in a round shape and, particularly, lots of space layers were distributed between each layer, as shown in FIG. 8.

1. A method for manufacturing ring-shaped multilayered bread, comprising the steps of:
(A) alternately and thinly laminating flour dough layers and milk fat layers so as to be laid upon one another and thus prepare a multilayered dough sheet;
(B) rolling the dough sheet into a long shape so as to prepare a dough roll and joining the both side end portions of the dough roll to each other so as to prepare a dough ring in the shape of a ring; and
(C) inserting the dough ring into a molding frame and baking the dough ring in a baking oven.

2. The method for manufacturing ring-shaped multilayered bread according to claim 1, wherein the step (A) is carried out at a temperature of 0˜5° C.

3. The method for manufacturing ring-shaped multilayered bread according to claim 1, wherein the multilayered dough sheet obtained in the step (A) has a thickness of 4˜7 mm, and the dough roll used in the step (B) is prepared by rolling the dough sheet 3˜4 times.

4. The method for manufacturing ring-shaped multilayered bread according to claim 1, wherein the dough ring obtained in the step (B) is prepared by a male-and-female coupling method such that one side end portion of the dough roll is completely inserted into the other side end portion thereof.

5. The method for manufacturing ring-shaped multilayered bread according to claim 1, wherein the molding frame of the step (C) has a central protrusion part, which is formed in the shape of a cylinder so as to be inserted into the center portion of the dough ring, and a round furrow part, which is formed in the periphery of the central protrusion part on the bottom surface of the molding frame so as to receive the dough ring.

6. The method for manufacturing ring-shaped multilayered bread according to claim 2, wherein the multilayered dough sheet obtained in the step (A) has a thickness of 4˜7 mm, and the dough roll used in the step (B) is prepared by rolling the dough sheet 3˜4 times.

7. The method for manufacturing ring-shaped multilayered bread according to claim 2, wherein the dough ring obtained in the step (B) is prepared by a male-and-female coupling method such that one side end portion of the dough roll is completely inserted into the other side end portion thereof.

8. The method for manufacturing ring-shaped multilayered bread according to claim 2, wherein the molding frame of the step (C) has a central protrusion part, which is formed in the shape of a cylinder so as to be inserted into the center portion of the dough ring, and a round furrow part, which is formed in the periphery of the central protrusion part on the bottom surface of the molding frame so as to receive the dough ring.
